(19) United States
(12) Patent Application Publication
(10) Pub. No.: US 2013/0173251 A1
(43) Pub. Date: Jul. 4, 2013

(54) ELECTRONIC DEVICE AND NATURAL LANGUAGE ANALYSIS METHOD THEREOF

(71) Applicants: Fu Tai Hua Industry (Shenzhen) Co., Ltd., Shenzhen (CN); HON HAI PRECISION INDUSTRY CO., LTD., New Taipei (TW)

(72) Inventors: YU-KAI XIONG, Shenzhen (CN); XIN LU, Shenzhen (CN); SHIH-FANG WONG, New Taipei (TW); HUI-FENG LIU, Shenzhen (CN); DONG-SHENG LV, Shenzhen (CN); YU-YONG ZHANG, Shenzhen (CN); JIAN-JIAN ZHU, Shenzhen (CN); XIANG-LIN CHENG, Shenzhen (CN); XIAO-SHAN ZHOU, Shenzhen (CN); XUAN-FEN HUANG, Shenzhen (CN); AN-LIN JIANG, Shenzhen (CN); XIN-HUA LI, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/710,480

(22) Filed: Dec. 11, 2012

(30) Foreign Application Priority Data
Dec. 29, 2011 (CN) 201110449948.1

(51) Int. Cl. G06F 17/28

(52) U.S. Cl. CPC G06F 17/28
USPC 704/9

(57) ABSTRACT

A natural language analysis method for an electronic device is provided. The language analysis method includes the steps of: receiving user inputs and generating signals; converting signals into textual information; segmenting the textual information into a number of vocabulary segments, each vocabulary segment including a number of separated vocabularies; retrieving the use frequency of each of vocabulary, sorting the vocabulary segments, and obtaining a first sorting of the number of vocabulary segments into descending order; segmenting the textual information into a number of sentence segmentations; obtaining a second sorting of the vocabulary segmentations, according to the number of sentence segmentations and the number of vocabulary segment results; and determining a reply to the textual information, according to the topmost result after the second sorting. An electronic device using the language analysis method is also provided.

### BACKGROUND

1. Technical Field

The present disclosure relates to an electronic device and a natural language analysis method thereof.

2. Description of Related Art

Some electronic devices with human-machine dialogue function, such as mobile phones, laptops, tablets, for example, are capable of voice interaction with users. How to exactly understand the natural language of users has been the challenge in artificial intelligence discipline for a long time. During the human-machine dialogue process, the electronic device segments a sentence of the user into pieces of words and/or phrases, analyzes the meanings of the sentence to exclude unreasonable meaning(s), then creates a machine readable interpretation language such as binary language, that is associated with the sentence of the user. The electronic device then understands the sentence of the user by using the created machine readable language and a vocabulary pre-stored therein, thus to obtain the meanings of the sentence of the user. However, misunderstandings often happen because of the complex nature of human language, in respect of accents and dialects.

Therefore, what is needed is an electronic device and a natural language analysis method thereof to alleviate the limitations described above.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding sections throughout the several views.

FIG. 1 is a block diagram of an electronic device in accordance with an exemplary embodiment.

FIG. 2 is a flowchart of a natural language analysis method for electronic devices, such as the one of FIG. 1, in accordance with the exemplary embodiment.

### DETAILED DESCRIPTION

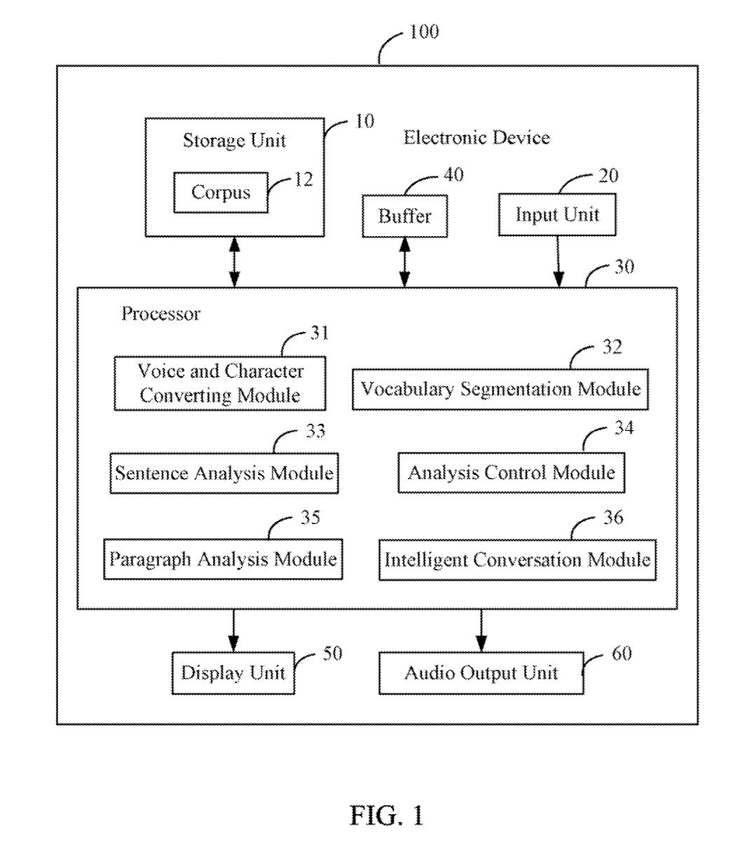

FIG. 1 is an exemplary embodiment of a block diagram of an electronic device 100. Compared to the electronic devices of related art, the electronic device 100 can more accurately understand the natural language of users, and has higher efficiency in human-machine dialogues. The electronic device 100 is a computing device such as a computer or a laptop. In alternative embodiments, the electronic device 100 can be other electronic devices with human-machine dialogue functions, such as a mobile phone, or a tablet, for example.

The electronic device 100 includes a storage unit 10, an input unit 20, a processor 30, a display unit 50, and an audio output unit 60. The storage unit 10 stores a collection of languages in one body (corpus 12) recording vast amount of vocabularies: words and phrases, and the use frequency of each word and each phrase. The corpus 12 is a collection of materials on language use which is selected and sequenced according to linguistic criterium. The corpus 12 is also a huge text database which is machine readable and is collected according to a particular design criterium. In the embodiment, the corpus 12 is a text database storing a huge number of Chinese natural languages. In other embodiments, the text databases of the kinds of language stored in the corpus 12 can be varied according to actual need, the corpus 12 can be a text database storing a huge number of the natural languages of English, of Japanese, or of others.

The input unit 20 generates signals in response to a user's voice and/or written character input, and transmits the signals to the processor 30. In the embodiment, the signals can be audio signals and/or character signals.

The processor 30 includes a voice and character converting module 31, a vocabulary segmentation module 32, a sentence analysis module 33, and an analysis control module 34.

When the electronic device 100 is powered on, the input unit 20 is activated and the user can talk to the electronic device 100 via the input unit 20, in the manner hereinafter described.

The voice and character converting module 31 converts the audio signals and/or character signals from the input unit 20 into a textualized message in a predetermined language. In the embodiment, the textualized message can include one or more words, one or more phrases, one or more sentences, and/or one or more paragraphs of a text, and the predetermined language is Chinese. In an alternative embodiment, the predetermined language can be English, or Japanese, or other language.

The vocabulary segmentation module 32 segments and divides the textualized message from the voice and character converting module 31 into one or more vocabularies, and obtains one or more segments including the one or more vocabularies. The vocabularized segments are further transmitted to the analysis control module 34. In the embodiment, the vocabulary segmentation module 32 segments the textualized message according to the bi-directional maximum matching method. That is, the vocabulary segmentation module 32 segments the textualized message forwardly and also reversely. For example, if the textualized message includes the sentence “the tiger killed the hunter's dog”, the vocabulary segmentation module 32 first segments the textualized message forwardly, and obtains one or more vocabularized segments. One segmented result may include the following vocabularies: “the tiger”, “killed”, “the hunter's”, and “dog”. Another segmented result may include the following vocabularies: “the tiger killed”, “the hunter's”, and “dog”. Yet another segmented result may include the following vocabularies: “the tiger killed the hunter” “'s dog”, or “the tiger”, “killed”, “the hunter's dog”. The vocabulary segmentation module 32 then segments the textualized message reversely, and obtains one or more vocabularized segments. The segmented result may include the following vocabularies: “the dog”, “the hunter's”, “killed”, and “the tiger”. Yet another segmented result may include the following vocabularies: “the dog”, “the hunter's”, “killed the tiger.”.

The analysis control module 34 retrieves the use frequency of each vocabularized segment created by the vocabulary segmentation module 32, from the corpus 12 stored in the storage unit 10. The analysis control module 34 also calculates a first probability value of each vocabularized segment based on the retrieved use frequency of each vocabularized segment, and obtains a first sequence of the language analysis results sequenced according to the first probability values of the vocabularized segments. In the embodiment, each segmented result is associated with a language analysis result. The larger the first probability value is, the nearer (more precise) or exact (correct) understanding of the user's meaning obtained according to the associated language analysis result. That is to say, the analysis control module 34 sequences the vocabularized segments according to the descending order of their probability values, and the language analysis result associated with the greatest first probability value is the first in the sequence downwards. In other words, the nearest or exact language analysis result is at the top.

The sentence analysis module 33 segments the textualized message from the voice and character converting module 31 based on the results obtained by the vocabulary segmentation module 32 and a sentence construction rule, and obtaining one or more sentence segments. The sentence analysis module 33 further transmits the sentence segments back to the analysis control module 34.

The analysis control module 34 further calculates a second probability value of each vocabularized segments based on the sentence segments, and adjusts the first sequence of the language analysis results according to the second probability values of the vocabularized segments, to obtain a second sequence of the language analysis results. In one embodiment, the analysis control module 34 excludes the vocabularized segments with the lowest second probability value, and deletes the associated language analysis result. In the embodiment, the smaller the second probability value of the sentence segment is, the farther is the deviation from correctly understanding the user's original meaning.

The processor 30 further includes a paragraph analysis module 35 which analyzes a number of textualized messages converted within a predetermined time period, including the original textualized message, according to a contextual understanding method, obtains one or more paragraph analysis results, and transmits the paragraph analysis results back to the analysis control module 34.

The analysis control module 34 further calculates a third probability value of each vocabularized segments based on the paragraph analysis results, adjusts the second sequence of the language analysis results according to the third probability values, and obtains a third sequence of the language analysis results. In one embodiment, the analysis control module 34 excludes the vocabularized segments(s) with the lowest third probability value, and deletes the associated language analysis result(s).

The processor 30 further includes an intelligent conversation module 36 which determines a message in reply (reply message) based on the language analysis result sequenced on the top, and the corpus 12. In the embodiment, the language analysis result which is finally at the top is the basis for the message in reply.

The voice and character converting module 31 further converts the reply message determined by the intelligent conversation module 36 into a reply message and/or corresponding vocal expression, and controls the display unit 50 to display the reply message and/or the audio output unit 60 to play the corresponding vocal expression.

The electronic device 100 further includes a buffer 40 used for temporarily storing certain data, namely, the reply message converted by the voice and character converting module 31, the vocabularies and the vocabularized segments segmented by the vocabulary segmentation module 32, the sentence segments segmented by the sentence analysis module 33, the paragraph analysis results analyzed by the paragraph analysis module 35, and the probability values of the vocabularized segments and the sequences obtained by the analysis control module 34.

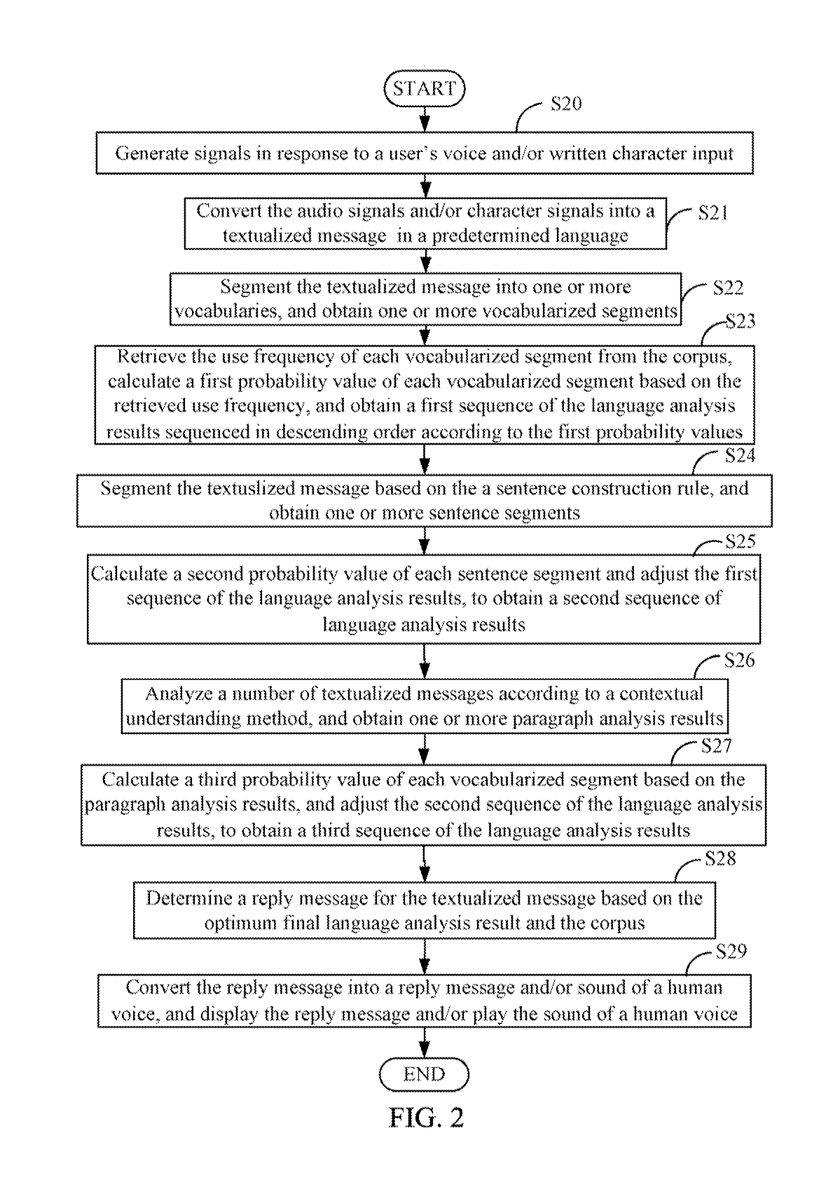

FIG. 2 shows a flowchart of a natural language analysis method for the electronic device 100 of FIG. 1. The electronic device 100 stores a corpus 12 recording vast amount of vocabularies: words and phrases, and the use frequency of each word and each phrase. The method includes the following steps, each of which is related to the various components contained in the electronic device 100:

In step S20, the input unit 20 generates signals in response to a user's voice and/or written character input. In the embodiment, the signals can be the sound of a voice and/or character signals.

In step S21, the voice and character converting module 31 converts the audio signals and/or character signals generated by the input unit 20 into a textualized message in a predetermined language. In the embodiment, the textualized message can include a word, a phrase, a sentence, and/or a paragraph, and the predetermined language is Chinese.

In step S22, the vocabulary segmentation module 32 segments the textualized message from the voice and character converting module 31 into one or more vocabularies, and obtains one or more vocabularized segments.

In step S23, the analysis control module 34 retrieves the use frequency of each vocabularized segment from the corpus 12, calculates a first probability value of each vocabularized segment based on the retrieved use frequency of each segment of vocabulary, and obtains a first sequence of the language analysis results sequenced in descending order according to the first probability values.

In step S24, the sentence analysis module 33 segments the textualized message converted by the voice and character converting module 31 based on a sentence construction rule, and obtains one or more sentence segments.

In step S25, the analysis control module 34 calculates a second probability value of each sentence segment, and adjusts the first sequence of the language analysis results according to the second probability values, to obtain a second sequence of language analysis results.

In step S26, the paragraph analysis module 35 analyzes a number of textualized messages converted within a predetermined time period to include the original textualized message according to a contextual understanding method, and obtains one or more paragraph analysis results. In the embodiment, it is the total number of textualized messages which are generated within a predetermined time period and includes the original textualized message.

In step S27, the analysis control module 34 calculates a third probability value of each vocabularized segment based on the paragraph analysis results, and adjusts the second sequence of the language analysis results according to the third probability values, to obtain a third sequence of the language analysis results.

In step S28, the intelligent conversation module 36 determines a reply message for the textualized message based on the optimum final language analysis result (the result at the top) and the corpus 12. In one embodiment, the language analysis result finally on top is the one sequenced according to the second sequence.

In step S29, the voice and character converting module 31 converts the reply message determined by the intelligent conversation module 36 into a reply message and/or sound of a human voice, and controls the display unit 50 to display the reply message and/or play the sound of a human voice through the audio output unit 60.

With such a configuration, the electronic device 100 is more able to understand the meanings of user's language, and vocal communication between the user and the electronic device 100 is more efficient.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A natural language analysis method for an electronic device storing a corpus recording vast amount of words and phrases and the use frequency of each word and each phrase, the method comprising:
generating signals in response to a user's input;
converting the signals into a textualized message in a predetermined language;
segmenting the textualized message into at least one vocabulary, and obtaining at least one vocabularized segments comprising the at least one vocabulary;
retrieving use frequency of each vocabularized segment from the corpus, calculating a first probability value of each vocabularized segment based on the retrieved use frequency of each segment of vocabulary, and obtaining a first sequence of language analysis results sequenced according to the first probability values;
segmenting the textualized message based on the vocabularized segments and a sentence construction rule, and obtaining at least one sentence segment;
calculating a second probability value of each vocabularized segments based on the at least one sentence segment, and adjusting the first sequence of the language analysis results according to the second probability values, to obtain a second sequence of language analysis results; and
determining a reply message based on the language analysis result sequenced on the top and the corpus.

2. The method as described in claim 1, further comprising steps before the “determining” step:
selecting a plurality of textualized messages consecutively converted within a predetermined time period, the selected textualized messages including said textualized message which is segmented later;
analyzing of the selected textualized messages using a contextual understanding method; and
calculating a third probability value of each vocabularized segment based on the paragraph analysis results, and adjust the second sequence of the language analysis results accordingly, to obtain a third sequence of the language analysis results.

3. The method as described in claim 2, further comprising:
excluding the vocabularized segments with the lowest third probability value, and deletes the associated language analysis result.

4. The method as described in claim 2, further comprising:
converting the reply message into a reply message or sound of a human voice; and
displaying the reply message or playing the sound of a human voice.

5. The method as described in claim 1, wherein the at least one vocabularized segments are sequenced according to the descending order of probability values.

6. The method as described in claim 1, further comprising:
excluding the vocabularized segments with the lowest second probability value, and deleting the language analysis result associated with the excluded vocabularized segments.

7. The method as described in claim 1, wherein the textualized message is segmented forwardly and also reversely.

8. The method as described in claim 1, wherein the corpus is a text database which is machine readable and is collected according to a given design criterium, and the predetermined language is Chinese or English.

9. The method as described in claim 1, wherein the user input is a voice input or a written character input.

10. The method as described in claim 1, wherein the textualized message is selected from the group consisting of: at least one word, at least one phrase, at least one sentence, and at least one paragraph of a text.

11. An electronic device comprising:
a storage unit, storing a corpus recording vast amount of words and phrases and the use frequency of each word and each phrase;
an input unit, configured for generating signals in response to a user's input;
a voice and character converting module, configured for converting the signals into a textualized message in a predetermined language;
a vocabulary segmentation module, configure for segmenting the textualized message into at least one vocabulary, and obtaining at least one vocabularized segments comprising the at least one vocabulary;
a sentence analysis module, configured for segmenting the textualized message based on the vocabularized segments and a sentence construction rule, and obtaining at least one sentence segment;
an analysis control module, configured for retrieving use frequency of each vocabularized segment from the corpus, calculating a first probability value of each vocabularized segment based on the retrieved use frequency of each vocabularized segment, obtaining a first sequence of language analysis results sequenced according to the first probability values, calculating a second probability value of each vocabularized segments based on the at least one sentence segment, and adjusting the first sequence of the language analysis results according to the second probability values, to obtain a second sequence of language analysis results; and
an intelligent conversation module, configured for determining a reply message based on the language analysis result sequenced on the top and the corpus.

12. The electronic device as described in claim 11, further comprising a paragraph analysis module configured for selecting a plurality of textualized messages consecutively converted within a predetermined time period, the selected textualized messages including said textualized message which is segmented later, and analyzing of the selected textualized messages using a contextual understanding method, wherein the analysis control module is further configured for calculating a third probability value of each vocabularized segment based on the paragraph analysis results, and adjusting the second sequence of the language analysis results accordingly, to obtain a third sequence of the language analysis results.

13. The electronic device as described in claim 12, wherein the analysis control module is further configured for excluding the vocabularized segments with the lowest second probability value, and deleting the associated language analysis result.

14. The electronic device as described in claim 12, wherein the voice and character converting module is further configured for converting the reply message into a reply message or sound of a human voice.

15. The electronic device as described in claim 12, further comprising a display unit for displaying the reply message and an audio output unit for playing the sound of a human.

16. The electronic device as described in claim 11, wherein the at least one vocabularized segments are sequenced according to the descending order of probability values.

17. The electronic device as described in claim 11, wherein the textualized message is segmented forwardly and also reversely.

18. The electronic device as described in claim 11, wherein the corpus is a text database which is machine readable and is collected according to a given certain design criterium, and the predetermined kind of language is Chinese or English.

19. The electronic device as described in claim 11, wherein the user input is a voice input or a written character input.

20. The electronic device as described in claim 11, wherein the textualized message is selected from the group consisting of: at least one word, at least one phrase, at least one sentence, and at least one paragraph of a text.
